(19) United States
(12) Patent Application Publication
(10) Pub. No.: US 2017/0244488 A1
(43) Pub. Date: Aug. 24, 2017

(54) SMART LABEL AND OPTICAL NETWORK MANAGEMENT APPARATUS USING THE SAME

(71) Applicant: Electronics and Telecommunications Research Institute, Daejeon (KR)

(72) Inventors: Jae In KIM, Gwangju (KR); Sung Chang KIM, Gwangju (KR); Geun Yong KIM, Gwangju (KR); Hee Do KIM, Seoul (KR); Moon Kyun OH, Daejeon (KR); Hark YOO, Gwangju (KR); Dong Soo LEE, Yongin (KR)

(21) Appl. No.: 15/439,876

(22) Filed: Feb. 22, 2017

(30) Foreign Application Priority Data
Feb. 24, 2016 (KR) 10-2016-0021818

(51) Int. Cl. H04B 10/27

(52) U.S. Cl. CPC H04B 10/27

(57) ABSTRACT

Provided are an electronic device, a smart label, and an optical network management apparatus using the same. The optical network management apparatus includes one or more smart labels respectively equipped in ports and cables to work and a terminal device configured to transmit control signals, which control smart labels respectively equipped in a port and a cable to work among the one or more smart labels, to smart labels respectively equipped in the port and the cable to work.

### CROSS-REFERENCE TO RELATED APPLICATIONS

This application claims priority under 35 U.S.C. §119 to Korean Patent Application No. 10-2016-0021818, filed on Feb. 24, 2016, the disclosure of which is incorporated herein by reference in its entirety.

### TECHNICAL FIELD

The present invention relates to an electronic device, and more particularly, to a smart label and an optical network management apparatus using the same.

### BACKGROUND

Passive optical network (PON) technology is technology that provides a subscriber with a network server at a fast transmission speed by using an optical fiber. A PON establishes and operates optical communication at low cost by using fiber to the home (FTTH) which is high-speed Internet facilities, and thus, replaces conventional technologies based on copper wires.

As the advance of the PON, the necessity of effectively collecting and managing information about a number of nodes and cables which connect the nodes is increasing. For example, a new optical cable and new nodes may be installed for a new subscriber. In this case, if optical cables which are managed by using a paper label are complicatedly installed inside a communication device where nodes are installed, which optical cable and port are connected to each other is inevitably dependent on a memory of an installer. Therefore, most of the cost relevant to the PON is expended in installing and managing an optical distribution network (ODN). Nodes of the PON are passive nodes, and thus, if the number of subscribers increases, a method of efficiently managing an ODN is needed.

### SUMMARY

Accordingly, the present invention provides a smart label for managing an enhanced optical network and an optical network management apparatus using the same.

In one general aspect, an optical network management apparatus includes one or more smart labels respectively equipped in ports and cables to work and a terminal device configured to transmit control signals, which control smart labels respectively equipped in a port and a cable to work among the one or more smart labels, to smart labels respectively equipped in the port and the cable to work.

In another general aspect, a smart label includes a communication unit configured to receive control signals, which issue a command to perform operations of one or more elements included in the smart label, from a terminal device and a control unit configured to perform the operations of the one or more elements corresponding to the control signals.

The terminal device may include a communication unit configured to receive the work list, including the port information and the cable information, from a management server and transmit a control signal to the smart labels respectively equipped in the port and the cable to work, a display unit configured to display the work list to a worker, and a control unit configured to provide a control signal, which issues a command to perform an operation of each of the smart labels respectively equipped in the port and the cable to work, to the smart labels respectively equipped in the port and the cable to work according to an input of the worker.

The management server may include a storage unit configured to store port information and cable information about nodes of an optical network, a control unit configured to generate the work list, based on the port information and the cable information, and a communication unit configured to transmit the generated work list to the terminal device.

Other features and aspects will be apparent from the following detailed description, the drawings, and the claims.

### BRIEF DESCRIPTION OF THE DRAWINGS

FIG. 1 is a diagram illustrating an optical network management system to which an embodiment of the present invention is applied.

FIG. 2 is a block diagram illustrating a structure of a smart label according to an embodiment of the present invention.

FIG. 3 is a block diagram illustrating a structure of a terminal device according to an embodiment of the present invention.

FIG. 4 is a block diagram illustrating a structure of a management server according to an embodiment of the present invention.

FIG. 5 is a diagram for describing an operation between a terminal device and a smart label according to an embodiment of the present invention.

FIG. 6 is a diagram for describing an operation between a terminal device and a smart label according to another embodiment of the present invention.

FIG. 7 is a diagram illustrating an embodiment where a smart label according to the present invention is installed in a cable.

FIG. 8 is a diagram illustrating an embodiment where a smart label according to the present invention is installed in a connection port.

FIG. 9 is a diagram illustrating another embodiment where a smart label according to the present invention is installed in a connection port.

FIG. 10 is a diagram illustrating another embodiment where a smart label according to the present invention is installed in a connection port.

FIG. 11 is a diagram for describing an optical network management method according to an embodiment of the present invention.

FIG. 12 is a flowchart illustrating an operation of the smart label of FIG. 2.

FIG. 13 is a flowchart illustrating an operation of the terminal device of FIG. 3.

FIG. 14 is a flowchart illustrating an operation of the management server of FIG. 4.

### DETAILED DESCRIPTION OF EMBODIMENTS

Explanation of the present invention is merely an embodiment for structural or functional explanation, so the scope of the present invention should not be construed to be limited to the embodiments explained in the embodiment.

Since the embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

It will be understood that although the terms including an ordinary number such as first or second are used herein to describe various elements, these elements should not be limited by these terms. These terms are only used to distinguish one element from another element. For example, a first element may be referred to as a second element without departing from the spirit and scope of the present invention, and similarly, the second element may also be referred to as the first element.

In the case in which a component is referred to as being “connected” or “accessed” to other component, it should be understood that not only the component is directly connected or accessed to the other component, but also there may exist another component between the components. Meanwhile, in the case in which a component is referred to as being “directly connected” or “directly accessed” to other component, it should be understood that there is no component therebetween.

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In describing embodiments, description on technology which is well known in the technical field of the present invention and is directly irrelevant to the present invention is omitted. This is for more clearly transferring subject matters of the present invention by omitting an unnecessary description in order not to obscure subject matters of the present invention.

An optical network described herein may be a PON. PON technology, point-to-multipoint optical network technology, is being standardized by IEEE and ITU-T, and various new technologies such as an Ethernet PON (EPON), a gigabyte PON (GPON), and a next-generation PON (for example, 10G, EPON, XG-PON, TWDM-PON, etc.) are being researched based on a data transmission speed.

With the advance of the PON technology, an optical network environment will advance to support a long-reach and high-split environment, and thus, requirements for managing an effective ODN are increasing. Therefore, the necessity of effectively collecting and managing information about a number of nodes and cables which connect the nodes is increasing.

Technology, which recognizes a port and a cable connector by applying technology such as radio frequency identification (RFID) to ports of nodes, may be considered for effectively managing an ODN. For example, when an RFID tag and a reader are located in ports of nodes, an event where a cable connector is coupled to or decoupled from a port of a node is detected, and there is a coupled cable, a method which allows an ID to be recognized may be considered. However, in order to apply such technologies, conventional passive nodes should be replaced with a new system, and the cost of an additional system for obtaining and transmitting ID information about an optical cable and a port of a node can be expended. Also, if a number of optical cables which are not fastened to a port are installed in a node, there is inefficiency in that a worker should manually find optical cables which are to be worked.

In the present specification, an RFID-based smart label and an apparatus and method of managing an optical network by using the same will be described in detail. Herein, the optical network management apparatus may include a terminal device and an external server. In embodiments, the terminal device may be an RF reader.

Hereinafter, embodiments of the present invention will be described in detail with reference to the accompanying drawings.

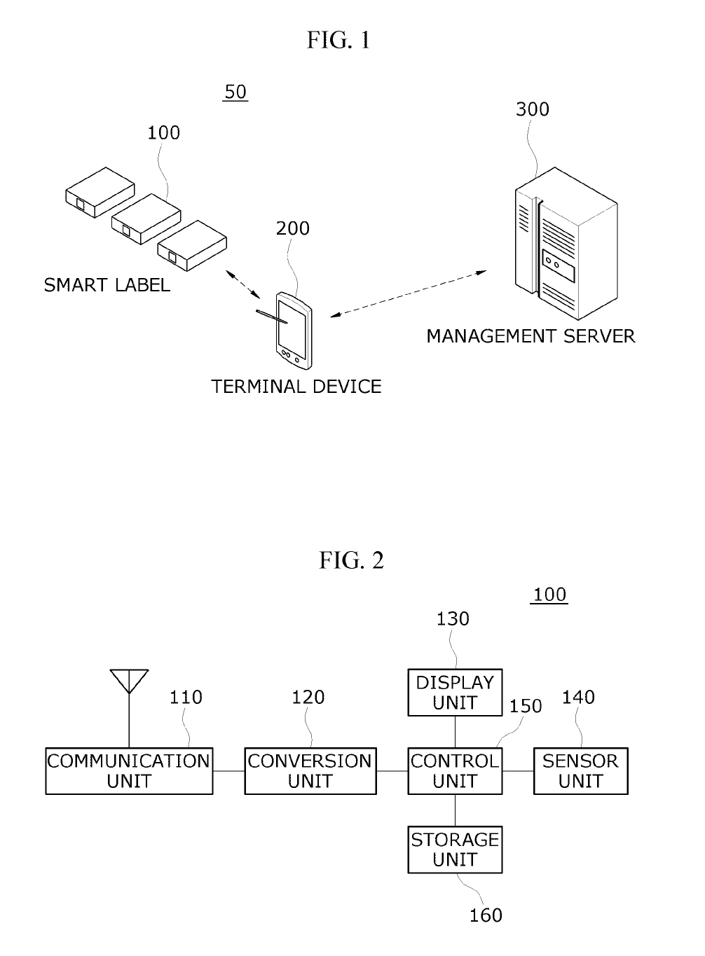

FIG. 1 is a diagram illustrating an optical network management system to which an embodiment of the present invention is applied.

Referring to FIG. 1, the optical network system may include one or more smart labels 100, a terminal device 200, and a management server 300.

The smart labels 100 may communicate with the terminal device 200. The smart labels 100 may communicate with the terminal device 200 by using a radio frequency (RF). Each of the smart labels 100 may be equipped in an optical cable or a port which is to be connected to the optical cable. Each of the smart labels 100 may have a unique ID and may be identified based on the ID. In an embodiment, the smart labels 100 may operate according to control by the terminal device 200. The smart labels 100 may each be a passive RF element.

The terminal device 200 may communicate with the smart labels 100 located within an arbitrary distance from the terminal device 200. The terminal device 200 may receive unique IDs of the smart labels 100 from the smart labels 100 and may identify the smart labels 100 by using the IDs. The terminal device 200 may communicate with the smart labels 100 to control operations of the smart labels 100. In an embodiment, the terminal device 200 may receive the IDs of the smart labels 100 to control an operation of the smart label 100 having a specific ID. The terminal device 200 may communicate with the smart label 100 for controlling a display unit or a sensor unit included in the smart label 100.

The management server 300 may communicate with the terminal device 200. The management server 300 may manage a work list. For example, the management server 300 may generate or update the work list including cable information about a cable to work and port information about a port to work. The cable information may include an ID of a smart label equipped in the cable, and the port information may include an ID of a smart label equipped in the port. The management server 300 may include a storage unit that stores the IDs of the smart labels 100 and information about a cable or a port equipped with the smart label 100, for managing the work list. A worker may perform a work, based on the work list generated by the management server 300. The work may include at least one of an operation of fastening a cable to a port, an operation of removing the cable from the port, and an operation of checking a connection state between the port and the cable.

The management server 300 may provide the terminal device 200 with the work list generated based on the information about each of the cable and the port which are to be worked. The management server 300 may receive the cable information about the cable which has been worked or the port information about the port which has been worked. The management server 300 may manage the work list, based on the cable information about the worked cable or the port information about the worked port.

FIG. 2 is a block diagram illustrating a structure of a smart label 100 according to an embodiment of the present invention.

Referring to FIG. 2, the smart label 100 may include a communication unit 110, a conversion unit 120, a display unit 130, a sensor unit 140, a control unit 150, and a storage unit 160.

The communication unit 110 may perform data communication with the terminal device 200 described above with reference to FIG. 1. The communication unit 110 may include an interface for communicating with the terminal device 200. In an embodiment, the communication unit 110 may communicate with the terminal device 200 in an RF manner.

The communication unit 110 may broadcast an ID signal including the ID of the smart label 100. The ID signal broadcasted by the communication unit 110 may be received by the terminal device 200 located within an arbitrary distance. In an embodiment, the communication unit 110 may receive a signal for requesting an ID from the terminal device 200 and may broadcast the ID signal in response to the received signal. The ID signal may be generated by the control unit 150, encoded by the conversion unit 120, and broadcasted by the communication unit 110.

In an embodiment, the communication unit 110 may receive signals transmitted from the terminal device 200. The communication unit 110 may transfer the signals, transmitted from the terminal device 200, to the conversion unit 120.

The conversion unit 120 may perform an encoding or decoding operation on the transferred signals. When an ID signal to transmit is received, the conversion unit 120 may encode the ID signal and may transfer the encoded ID signal to the communication unit 110. In an embodiment, the DI signal may not be generated by the control unit 150, and the communication unit 110 may directly generate the ID signal and may broadcast the generated ID signal without undergoing the conversion unit 120.

The conversion unit 120 may receive the signals received by the communication unit 110 and may decode the received signals. The conversion unit 120 may decode the received signals to determine whether each of the received signals is a signal corresponding to a corresponding smart label 100. In an embodiment, when the decoding succeeds, the conversion unit 120 may determine the received signal as the signal corresponding to the corresponding smart label 100. When the decoding fails, the conversion unit 120 may determine that the received signal is not the signal corresponding to the corresponding smart label 100. When the decoding fails, the conversion unit 120 may discard the received signal.

The display unit 130 may display a state of the smart label 100. In an embodiment, the display unit 130 may include a light emitting diode (LED) for displaying the state of the smart label 100. The display unit 130 may operate in an on/off state according to control by the control unit 150. In an embodiment, the display unit 130 may include an LED for displaying various colors. The display unit 130 may display a specific color according to control by the control unit 150.

The sensor unit 140 may sense a temperature of the smart label 100 or an ambient environment of the smart label 100. In an embodiment, the sensor unit 140 may include a temperature sensor or an illumination sensor. In an embodiment of the present invention, the kind of a sensor included in the sensor unit 140 is not limited. The sensor unit 140 may sense a temperature of the smart label 100 or an illumination of the display unit 130 included in the smart label 100 according to control by the control unit 150 and may transfer a sensing result to the control unit 150.

In an embodiment, although not shown, the sensor unit 140 may include at least one of a gesture sensor, a gyro sensor, a pressure sensor, a magnetic sensor, an acceleration sensor, a grip sensor, a proximity sensor, a color sensor (for example, a red, green, and blue (RGB) sensor), a bio sensor, a humidity sensor, an ultraviolet (UV) sensor. Additionally or alternatively, the sensor unit 140 may include an E-nose sensor, an electromyography (EMG) sensor, an electroencephalogram (EEG) sensor, an electrocardiogram (ECG) sensor, an infrared sensor, an iris sensor, a fingerprint sensor, and/or the like. In an embodiment, the sensor unit 140 may further include a control circuit for controlling one or more sensors included in the sensor unit 140.

The control unit 150 may control an overall operation of the smart label 100. When a signal for requesting an ID signal is received from the terminal device 200, the control unit 150 may generate the ID signal and may perform control in order for the ID signal to be broadcasted through the communication unit 110.

When a signal for requesting an ID is received from the terminal device 200, the control unit 150 may generate an ID signal and may broadcast, through the communication unit 110, the ID signal to the terminal device 200.

The control unit 150 may control the display unit 140 or the sensor unit 150 according to a control signal received from the terminal device 200. For example, the control unit 150 may receive various control signals from the terminal device 200. The control unit 150 may receive a control signal, which allows the display unit 140 to be put in the on/off state, from the terminal device 200. The control unit 150 may receive a control signal, which allows data of the sensor unit 140 to be transmitted, from the terminal device 200. In an embodiment, the control unit 150 may be implemented with a central processing unit (CPU).

The storage unit 160 may store a unique ID of the smart label 100. In an embodiment, the storage unit 160 may be included in the control unit 150.

In an embodiment, although not shown, the smart label 100 may further include a power unit for driving the smart label 100. The power unit may include a passive battery (for example, a capacitor) or an active battery depending on an implementation method. The power unit may drive the communication unit 110, the conversion unit 120, the display unit 130, the sensor unit 140, the control unit 150, and the storage unit 160. In an embodiment, the power unit may be charged by using an RF signal received by the communication unit 110.

In an embodiment, the smart label 100 may include elements for performing various functions, in addition to the display unit 140 and the sensor unit 150.

One or more elements included in the smart label 100 may operate according to control signals received from the terminal device 200. In an embodiment, the one or more elements may be set to one of an on state and an off state according to the control signals.

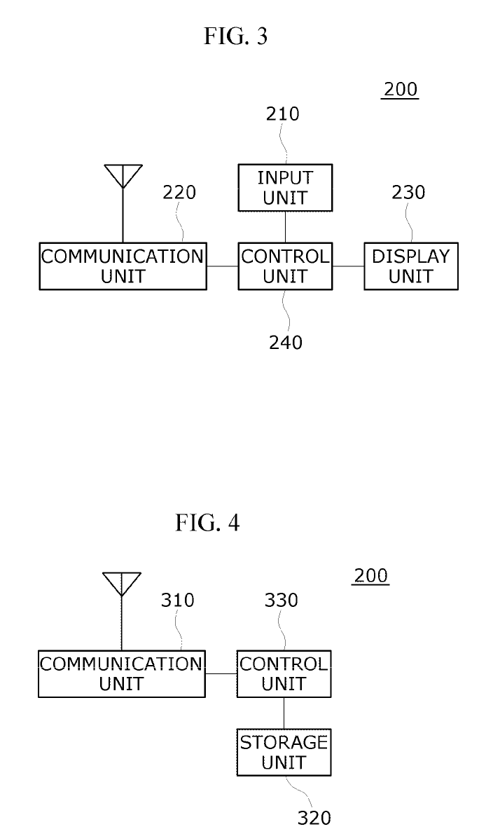

FIG. 3 is a block diagram illustrating a structure of a terminal device 200 according to an embodiment of the present invention.

The terminal device 200 may include an input unit 210, a communication unit 220, a display unit 230, and a control unit 240.

The input unit 210 may transfer a command or data, which is input through an input device (for example, a sensor, a keyboard, or a touch screen) from a worker, to the control unit 240. For example, the input unit 210 may provide data, which is generated based on a touch of the worker input through the touch screen, to the control unit 240. In various embodiments, the input unit 210 may include a touch panel, a (digital) pen sensor, a key, or an ultrasonic input device.

The communication unit 220 may receive a work list from the management server 300. The work list may include cable information about a cable to work and port information about a port to work. The cable information may include an ID of a smart label equipped in the cable, and the port information may include an ID of a smart label equipped in the port. A worker may perform a work, based on the work list. Here, the work may include at least one of an operation of fastening a cable to a port, an operation of removing the cable from the port, and an operation of checking a connection state between the port and the cable.

In order to receive IDs of smart labels 100 located near the terminal device 200, the communication unit 220 may transmit a signal, which requests the IDs, to the smart labels 100.

In an embodiment, the communication unit 210 may respectively transmit control signals to the smart labels 100. The control signals may be signals for controlling turn-on/off of the display unit 140 included in each of the smart labels 100 or signals for controlling various elements included in the smart labels 100.

In an embodiment, the communication unit 220 may provide cable information about a worked cable or port information about a worked port according to an input received through the input unit 210.

The communication unit 220 may include a communication interface for communicating with the smart label 100 or the management server 300. For example, the communication unit 220 may communicate with the smart label 100 or the management server 300 through wired communication or wireless communication. The wired communication may include, for example, at least one of RF, wireless fidelity (Wi-Fi), Bluetooth (BT), near field communication (NFC), a global positioning system (GPS), cellular communication (for example, LTE, LTE-A, CDMA, WCDMA, UMTS, WiBro, GSM, etc.). The wired communication may include, for example, at least one of universal serial bus (USB), high definition multimedia interface (HDMI), RJ45, recommended standard 232 (RS-232), and plain old telephone service (POTS).

The display unit 230 may display various pieces of information to a worker. The display unit 230 may display a work list received through the communication unit 220 from the management server 300. In an embodiment, the display unit 230 may include a panel, a hologram device, or a projector. The panel may be, for example, a liquid crystal display (LCD), an active-matrix organic light emitting diode (AM-OLED), or the like. In an embodiment, the panel may be implemented to be flexible, transparent, or wearable. The panel may be configured as one module with a touch screen of the input unit 210. The hologram device may display a three-dimensional (3D) image on the air by using interference of light. The projector may project light onto a screen to display an image. The screen may be disposed inside or outside the terminal device 200. In an embodiment, the display unit 230 may further include a control circuit for controlling the panel, the hologram device, or the projector.

The display unit 230 may provide a user interface (UI) for the worker. For example, the display unit 230 may provide an UI for transmitting the work list or control signals to the smart labels 100 for a work.

The control unit 240 may control an overall operation of the terminal device 200. The control unit 240 may receive data from each of the above-described other elements (for example, the input unit 210, the communication unit 220, and the display unit 230), decode the received data, and perform an arithmetic operation or data processing based on a decoded command.

In an embodiment, the control unit 240 may generate control signals for controlling the smart labels 100 according to an input received through the input unit 210 and may provide the generated control signals to the smart labels 100 through the communication unit 220.

In an embodiment, the control unit 240 may provide cable information about a worked cable or port information about a worked port to the management server 300 through the communication unit 220 according to an input received through the input unit 210.

Although not shown, the terminal device 200 may further include a storage unit for storing data received from the smart labels 100 or the management server 300.

FIG. 4 is a block diagram illustrating a structure of a management server 300 according to an embodiment of the present invention.

Referring to FIG. 4, the management server 300 may include a communication unit 310, a storage unit 320, and a control unit 330.

The communication unit 310 may perform data communication with the terminal device 200 described above with reference to FIG. 3. The communication unit 310 may include a communication interface for communicating with the terminal device 200. For example, the communication unit 310 may communicate with the terminal device 200 through wired communication or wireless communication. The wired communication may include, for example, at least one of RF, wireless fidelity (Wi-Fi), Bluetooth (BT), near field communication (NFC), a global positioning system (GPS), cellular communication (for example, LTE, LTE-A, CDMA, WCDMA, UMTS, WiBro, GSM, etc.). The wired communication may include, for example, at least one of universal serial bus (USB), high definition multimedia interface (HDMI), RJ45, recommended standard 232 (RS-232), and plain old telephone service (POTS).

The communication unit 310 may provide a work list to the terminal device 200. In an embodiment, the communication unit 310 may provide cable information about a worked cable or port information about a worked port from the terminal device 200.

The storage unit 320 may store port information or cable information about nodes included in a network. The port information may include IDs of the smart labels 100 equipped in a corresponding port, and the cable information may include IDs of the smart labels 100 equipped in a corresponding cable.

In an embodiment, the storage unit 320 may include an internal memory or an external memory. The internal memory may include, for example, at least one of a volatile memory (for example, dynamic random access memory (DRAM), static random access memory (SRAM), synchronous DRAM (SDRAM), etc.) and a non-volatile memory (for example, one time programmable read-only memory (OTPROM), programmable ROM (PROM), erasable and programmable ROM (EPROM), electrically erasable and programmable ROM (EEPROM), mask ROM, flash ROM, NAND flash memory, NOR flash memory, etc.).

The internal memory may be a solid state drive (SSD). The external memory may further include flash drive, for example, compact flash (CF), secure digital (SD), micro secure digital (Micro-SD), mini secure digital (Mini-SD), extreme digital (xD), or memory stick. The external memory may be functionally connected to the management server 300 through various interfaces.

The control unit 330 may control an overall operation of the management server 300. The control unit 330 may generate a work list which is stored in the storage unit 320 and includes cable information or port information. The cable information may include an ID of a smart label equipped in a cable, and the port information may include an ID of a smart label equipped in a port. A worker may perform a work, based on the generated work list. The work may include at least one of an operation of fastening a cable to a port, an operation of removing the cable from the port, and an operation of checking a connection state between the port and the cable.

The worker performs a work, and then, when cable information about a worked cable or port information about a worked port is received, the control unit 330 may update the work list. For example, the control unit 330 may receive the cable information about the worked cable or the port information about the worked port from the terminal device 200. The control unit 330 may manage the work list, based on the cable information about the worked cable or the port information about the worked port.

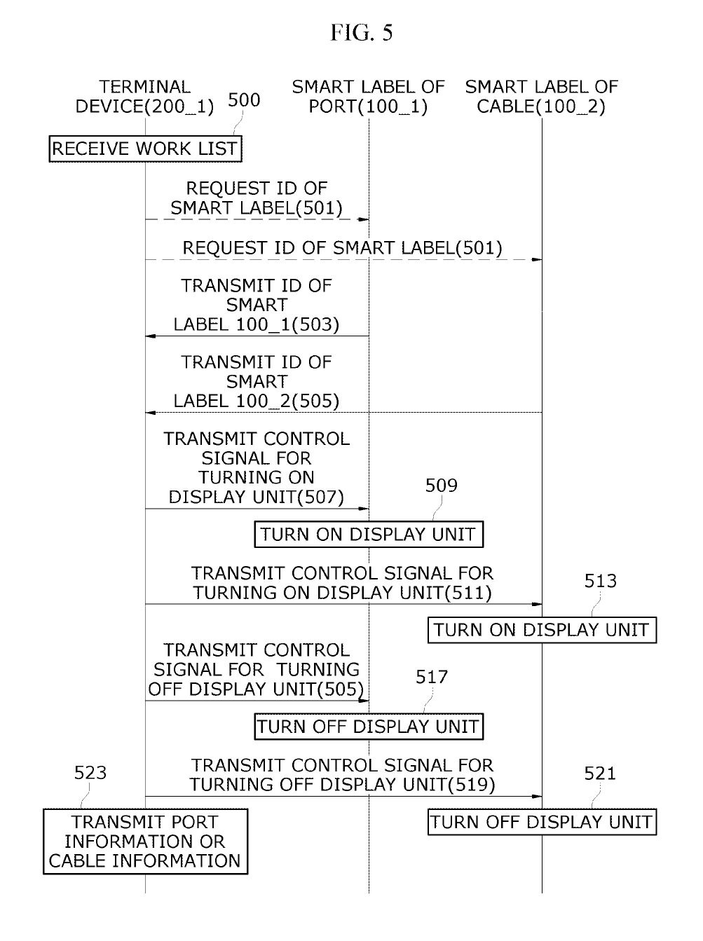

FIG. 5 is a diagram for describing an operation between a terminal device and a smart label according to an embodiment of the present invention.

FIG. 5 illustrates an operation of fastening, by a terminal device 200_1, a port to a cable or removing the cable connected to the port.

Referring to FIG. 5, in step 500, the terminal device 200_1 may receive a work list from a management server. The work list may include cable information about a cable to work and port information about a port to work. The cable information may include an ID of a smart label equipped in a corresponding cable, and the port information may include an ID of a smart label equipped in a corresponding port. A worker may perform a work, based on the work list. Here, the work may include at least one of an operation of fastening a cable to a port, an operation of removing the cable from the port, and an operation of checking a connection state between the port and the cable.

In step 501, the terminal device 200_1 may transmit a signal, which requests an ID of each smart label, to a smart label 100_1 (hereinafter referred to as a smart label of a port) equipped in a port to fasten or remove and a smart label 100_2 (hereinafter referred to as a smart label of a cable) equipped in a cable to fasten or remove. In an embodiment, step 501 may be omitted. Therefore, the terminal device 200_1 may broadcast an ID signal including an ID of each of the smart label 100_1 of the port and the smart label 100_2 of the cable without transmitting a signal, which requests an ID, to the smart label 100_1 of the port and the smart label 100_2 of the cable.

In step 503, the smart label 100_1 of the port may transmit an ID to the terminal device 200_1.

In step 505, the smart label 100_2 of the cable may transmit an ID to the terminal device 200_1.

The worker may check an ID of a port or a cable, which is to be fastened or removed, in the work list displayed by a display unit of the terminal device 200_1.

In step 507, the terminal device 200_1 may transmit a control signal, which issues a command to set a display unit to an on state, to the smart label 100_1 of the port. The control signal transmitted to the smart label 100_1 of the port may be a signal including the ID of the smart label 100_1 of the port. In an embodiment, the terminal device 200_1 may transmit a control signal which issues a command to set the display unit of the smart label 100_1 of the port to a flickering state where the on state and an off state are alternately repeated.

In step 509, the smart label 100_1 of the port may set the display unit to the on state. In an embodiment, the smart label 100_1 may set the display unit to the flickering state where the on state and the off state are alternately repeated.

In step 511, the terminal device 200_1 may transmit a control signal, which issues a command to set a display unit to the on state, to the smart label 100_2 of the cable. The control signal transmitted to the smart label 100_2 of the cable may be a signal including the ID of the smart label 100_2 of the cable. In an embodiment, the terminal device 200_1 may transmit a control signal which issues a command to set the display unit of the smart label 100_2 of the cable to the flickering state where the on state and the off state are alternately repeated.

In step 513, the smart label 100_2 of the cable may set the display unit to the on state. In an embodiment, the smart label 100_2 of the cable may set the display unit to the flickering state where the on state and the off state are alternately repeated.

In an embodiment, steps 507 to 513 may not sequentially be performed. For example, a control signal for the smart label 100_2 of the cable may be first transmitted, and then, a control signal for the smart label 100_1 of the port may be transmitted.

In an embodiment, instead of steps 507 to 513, other elements included in each of the smart label 100_1 of the port and the smart label 100_2 of the cable may be controlled. For example, the terminal device 200_1 may transmit control signals, which control other elements instead of controlling the display unit to the on state, to the smart label 100_1 of the port and the smart label 100_2 of the cable.

When there are a plurality of cables and ports, the worker may intuitively recognize a port and a cable, which are to be fastened or removed, through the display units of the smart label 100_1 equipped in the port and the smart label 100_2 equipped in the cable. The worker may find smart labels 100_1 and 100_2 where the display unit is set to the on state, and may fasten or remove a port and a cable respectively equipped with the smart labels 100_1 and 100_2.

In step 515, the terminal device 200_1 may transmit a control signal, which issues a command to set the display unit to the off state, to the smart label 100_1 of the port. The control signal transmitted to the smart label 100_1 of the port may be a signal including the ID of the smart label 100_1 of the port.

In step 517, the smart label 100_1 of the port may set the display unit to the off state.

In step 519, the terminal device 200_1 may transmit a control signal, which issues a command to set the display unit to the off state, to the smart label 100_2 of the cable. The control signal transmitted to the smart label 100_2 of the cable may be a signal including the ID of the smart label 100_2 of the cable.

In step 521, the smart label 100_2 of the cable may set the display unit to the off state.

In step 523, the terminal device 200_1 may provide cable information about a fastened or removed cable or port information about a fastened or removed port to the management server.

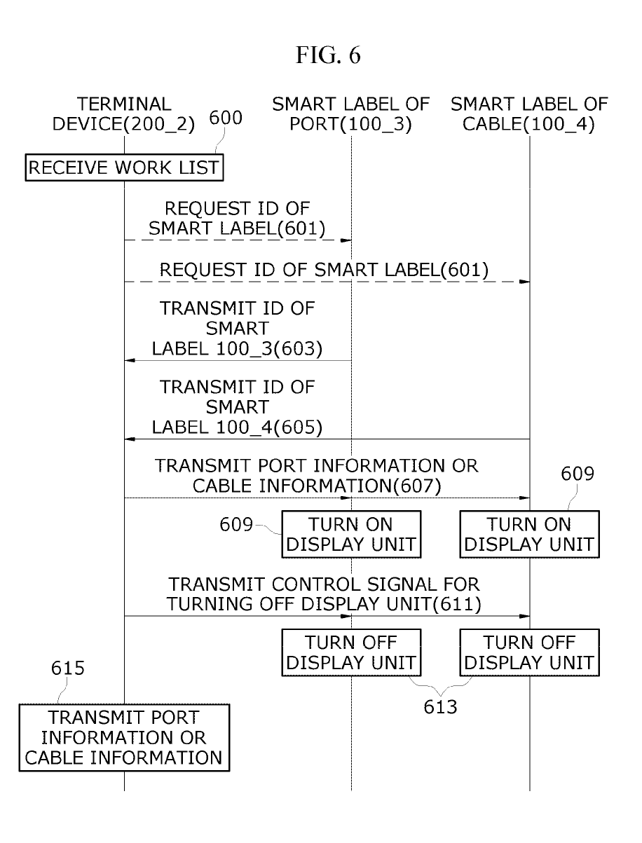

FIG. 6 is a diagram for describing an operation between a terminal device and a smart label according to another embodiment of the present invention.

FIG. 6 illustrates an operation of checking, by a terminal device 200_2, a cable connected to a port. For example, a worker may determine, through the operation of FIG. 6, whether the port is normally fastened to the cable.

Referring to FIG. 6, in step 600, the terminal device 200_2 may receive a work list from a management server. The work list may include cable information about a cable to work and port information about a port to work. The cable information may include an ID of a smart label equipped in a corresponding cable, and the port information may include an ID of a smart label equipped in a corresponding port. The worker may perform a work, based on the work list. Here, the work may include at least one of an operation of fastening a cable to a port, an operation of removing the cable from the port, and an operation of checking a connection state between the port and the cable.

In step 601, the terminal device 200_2 may transmit a signal, which requests an ID of each smart label, to a smart label 100_3 (hereinafter referred to as a smart label of a port) equipped in a port of a node to check and a smart label 100_4 (hereinafter referred to as a smart label of a cable) equipped in a cable to check. In an embodiment, step 601 may be omitted. Therefore, the terminal device 200_2 may broadcast an ID signal including an ID of each of the smart label 100_3 of the port and the smart label 100_4 of the cable without transmitting a signal, which requests an ID, to the smart label 100_3 of the port and the smart label 100_4 of the cable.

In step 603, the smart label 100_3 of the port may transmit an ID to the terminal device 200_2.

In step 605, the smart label 100_4 of the cable may transmit an ID to the terminal device 200_2.

The worker may check an ID of a port or a cable, which is to be checked, in the work list displayed by a display unit of the terminal device 200_2.

In step 607, the terminal device 200_2 may transmit control signals, which issue a command to set a display unit to an on state, to the smart label 100_3 of the port and the smart label 100_4 of the cable which are fastened to each other in pairs. The control signal transmitted to the smart label 100_3 of the port may be a signal including the ID of the smart label 100_3 of the port, and the control signal transmitted to the smart label 100_4 of the cable may be a signal including the ID of the smart label 100_4 of the cable. In an embodiment, the terminal device 200_2 may transmit a control signal which issues a command to set the display unit of the smart label 100_3 of the port and the display unit of the smart label 100_4 of the cable to a flickering state where the on state and an off state are alternately repeated. In an embodiment, the control signals transmitted to the smart label 100_3 of the port and the smart label 100_4 of the cable may be sequentially or simultaneously transmitted.

In step 609, the smart label 100_3 of the port may set the display unit to the on state, and the smart label 100_4 of the cable may set the display unit to the on state. In an embodiment, each of the smart label 100_3 of the port and the smart label 100_4 of the cable may set the display unit to the flickering state where the on state and the off state are alternately repeated.

In an embodiment, instead of steps 607 and 609, other elements included in each of the smart label 100_3 of the port and the smart label 100_4 of the cable may be controlled. For example, the terminal device 200_2 may transmit control signals, which control other elements instead of controlling the display unit to the on state, to the smart label 100_3 of the port and the smart label 100_4 of the cable.

When there are a plurality of cables and ports, the worker may intuitively check, through display units of smart labels 100_3 and 100_4 respectively equipped in a port and a cable, whether the port is normally fastened to the cable. The worker may check smart labels 100_3 and 100_4, where a display unit is set to the on state, with eyes and may check a connection state between a port and a cable respectively equipped with smart labels 100_3 and 100_4.

In step 611, the terminal device 200_2 may transmit a control signal, which issues a command to set a display unit to the off state, to the smart label 100_1 of the port and the smart label 100_4 of the cable. The control signal transmitted to the smart label 100_3 of the port may be a signal including an ID of the smart label 100_3 of the port, and the control signal transmitted to the smart label 100_4 of the cable may be a signal including an ID of the smart label 100_4 of the cable.

In step 613, the smart label 100_3 of the port may set the display unit to the off state, and the smart label 100_4 of the cable may set the display unit to the off state.

In step 615, the terminal device 200_2 may transmit cable information about a checked cable or port information about a checked port to the management server.

In an embodiment, when there are a plurality of port-cable pairs to check, steps 607 to 613 may be repeatedly performed.

The worker may check, through a check operation described above with reference to FIG. 6, whether a cable is accurately connected to a port. For example, the worker may operate display units, respectively included in a smart label of a port and a smart label of a cable, as one pair. The worker may perform a check operation by checking display units included in respective smart labels of a port and an optical cable displayed as one pair. For example, when a cable is connected to an undesired port, a display unit of a smart label may be displayed on another port instead of a fastened port. In this case, the worker may correct an abnormal connection, or may report a current state and a countermeasure state to the management server.

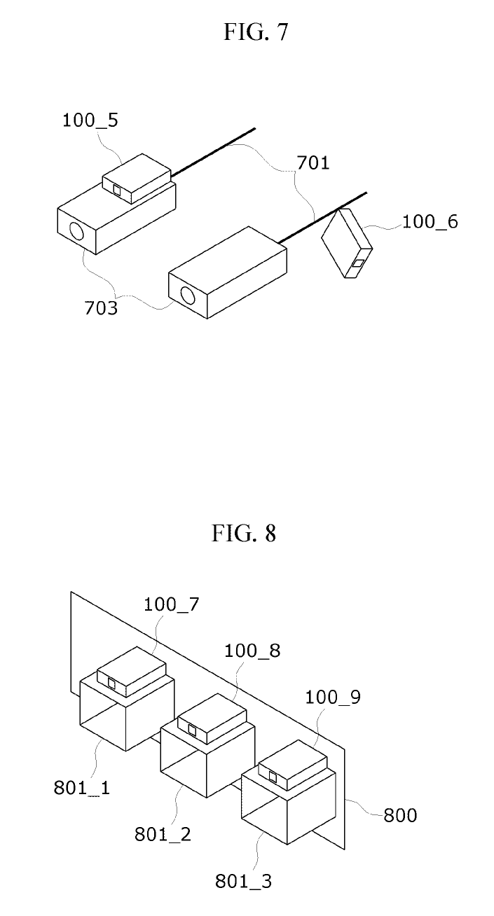

FIG. 7 is a diagram illustrating an embodiment where a smart label according to the present invention is installed in a cable.

Referring to FIG. 7, a smart label 100_5 may be equipped in a connector 703 that connects a cable 701 and a port. In various embodiments, a smart label 100_6 may be directly equipped in a cable 701 itself. The equipped smart labels 100_5 and 100_6 may be used to identify the cable 701, and cable information stored in a management server may include an ID of the cable 701 and IDs of the smart labels 100_5 and 100_6 equipped in the cable 701.

FIG. 8 is a diagram illustrating an embodiment where a smart label according to the present invention is installed in a connection port.

Referring to FIG. 8, a node 800 may include a plurality of ports 801_1 to 801_3 which are to be fastened to cables. A plurality of smart labels 100_7 to 100_9 may be directly equipped in the respective ports 801_1 to 801_3 so as to identify the ports 801_1 to 801_3. The equipped smart label 100_7 may be used to identify the port 801_1, the smart label 100_8 may be used to identify the port 801_2, and the smart label 100_9 may be used to identify the port 801_3. Port information stored in a management server may include IDs of the ports 801_1 to 801_3 and IDs of the smart labels 100_7 to 100_9 respectively equipped in the ports 801_1 to 801_3.

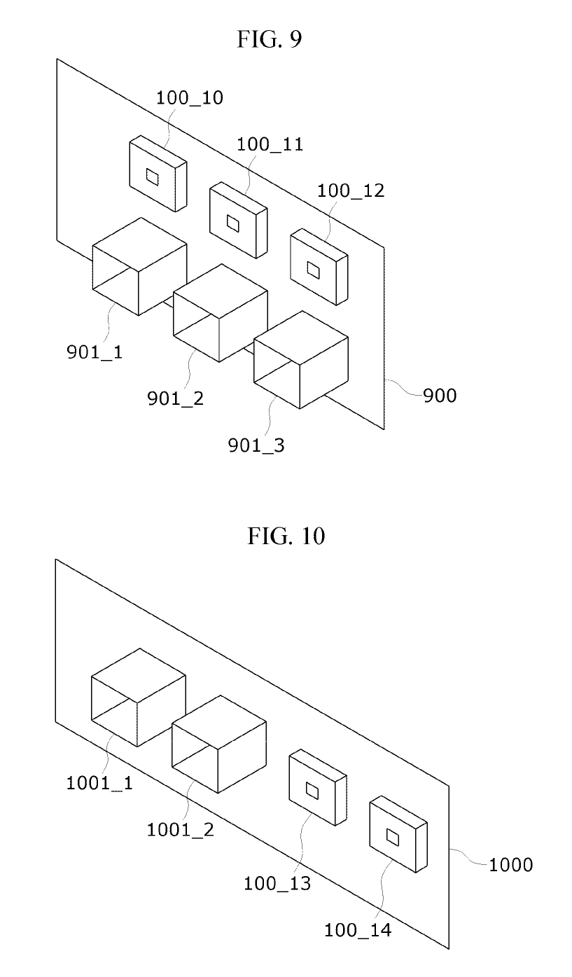

FIG. 9 is a diagram illustrating another embodiment where a smart label according to the present invention is installed in a connection port.

Referring to FIG. 9, a node 900 may include a plurality of ports 901_1 to 901_3 which are to be fastened to cables. A plurality of smart labels 100_10 to 100_12 may be equipped in the node 900. For example, the smart labels 100_10 to 100_12 may be equipped in areas respectively corresponding to positions of the ports 901_1 to 901_3 in the node 900. The equipped smart label 100_10 may be used to identify the port 901_1, the smart label 100_11 may be used to identify the port 901_2, and the smart label 100_12 may be used to identify the port 901_3. Port information stored in a management server may include IDs of the ports 901_1 to 901_3 and IDs of the smart labels 100_10 to 100_12 for identifying a corresponding port.

FIG. 10 is a diagram illustrating another embodiment where a smart label according to the present invention is installed in a connection port.

Referring to FIG. 10, a node 1000 may include a plurality of ports 1001_1 and 1001_2 which are to be fastened to cables. A plurality of smart labels 100_13 and 100_14 may be equipped in the node 1000. For example, the smart labels 100_13 and 100_14 may be equipped in areas respectively corresponding to positions of the ports 1001_1 and 1001_2 in the node 1000. The equipped smart label 100_13 may be used to identify the port 1001_1, and the smart label 100_14 may be used to identify the port 1001_2. Port information stored in a management server may include IDs of the ports 1001_1 and 1001_2 and IDs of the smart labels 100_13 and 100_14 for identifying the ports 1001_1 and 1001_2.

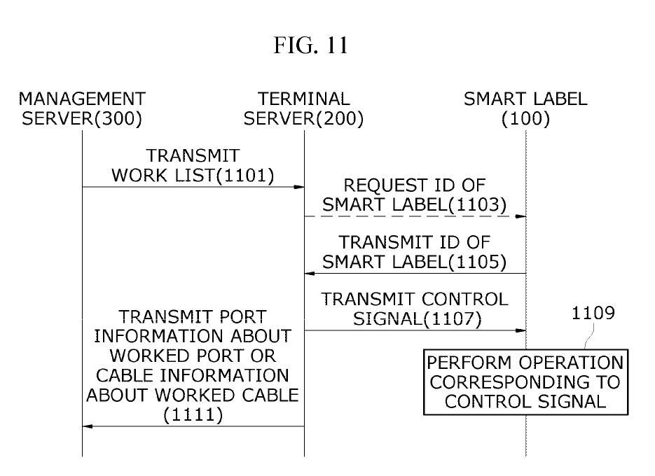

FIG. 11 is a diagram for describing an optical network management method according to an embodiment of the present invention.

Referring to FIG. 11, in step 1101, a management server 300 may transmit a work list to a terminal device 200. The work list may include cable information about a cable to work and port information about a port to work. The cable information may include an ID of a smart label equipped in a corresponding cable, and the port information may include an ID of a smart label equipped in a corresponding port. The worker may perform a work, based on the work list. Here, the work may include at least one of an operation of fastening a cable to a port, an operation of removing the cable from the port, and an operation of checking a connection state between the port and the cable.

The worker may identify IDs of smart labels 100 located near the terminal device 200, for performing one or more works included in the work list. For example, in step 1103, the terminal device 200 may request IDs of the smart labels 100 from the smart labels 100. In an embodiment, step 1103 may be omitted. For example, without an operation of requesting, by the terminal device 200, the ID of the smart label 100, the smart label 100 may directly broadcast an ID signal including its own ID, and the terminal device 200 may receive the ID signal to obtain the IDs of the smart labels located near the terminal device 200.

In step 1105, the smart label 100 may transmit the ID signal including the ID of the smart label 100 to the terminal device 200.

In step 1107, the worker may check, through the work list, an ID of a smart label 100 which is to be worked, and may control the terminal device 200 to transmit a control signal to the smart label 100 which is to be worked.

The control signal may be a signal which issues a command to perform a specific operation of the smart label 100, for controlling various elements included in the smart label 100. In an embodiment, the control signal may be a signal for controlling turn-on/off of a display unit included in the smart label 100. In an embodiment, the control signal may be a signal for controlling an operation of a sensor unit included in the smart label 100.

In step 1109, the smart label 100 may perform an operation corresponding to the transmitted control signal. For example, in a fastening or removing operation, the smart label 100 may perform an operation of setting the display unit, included in the smart label 100, to an on state. In an embodiment, the smart label 100 may perform an operation of setting the display unit to a flickering state where the on state and an off state are alternately repeated.

In an embodiment, steps 1107 to 1109 may be performed based on a work which is to be performed. For example, in performing a check operation, the terminal device 200 may transmit control signals to the smart labels 100 of a port and a cable which are to be checked, and may perform an operation corresponding to the control signals received by the smart labels 100 of the port and the cable.

When a work is completed, in step 1111, the terminal device 200 may transmit port information about a worked port or cable information about a worked cable to the management server 300.

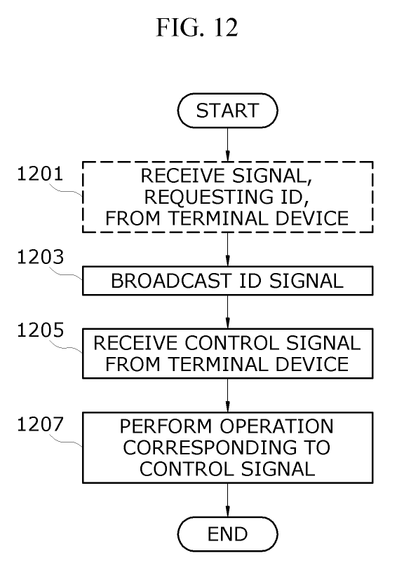

FIG. 12 is a flowchart illustrating an operation of the smart label of FIG. 2.

Referring to FIG. 12, in step 1201, the smart label may receive a signal, which is requests an ID, from a terminal device. In an embodiment, step 1201 may be omitted. For example, in step 1203, the smart label may broadcast an ID signal including the ID without receiving a request of the smart label.

In step 1205, the smart label may receive a control signal from the terminal device.

In step 1207, the smart label may perform an operation corresponding to the received control signal.

In an embodiment, the control signal may be a signal for controlling elements included in the smart label. For example, the control signal may be a signal for controlling turn-on/off of a display unit included in the smart label. In an embodiment, the control signal may be a signal for controlling an operation of a sensor unit included in the smart label.

In step 1207, the smart label may perform an operation corresponding to the received control signal. For example, the smart label may perform an operation of setting the display unit, included in the smart label, to an on state. In an embodiment, the smart label may perform an operation of setting the display unit to a flickering state where the on state and an off state are alternately repeated. In an embodiment, the smart label may perform an operation of transmitting a result of sensing by a sensor, included in the sensor unit, to the terminal device.

In an embodiment, steps 1205 and 1207 may be repeated based on a work which is to be performed.

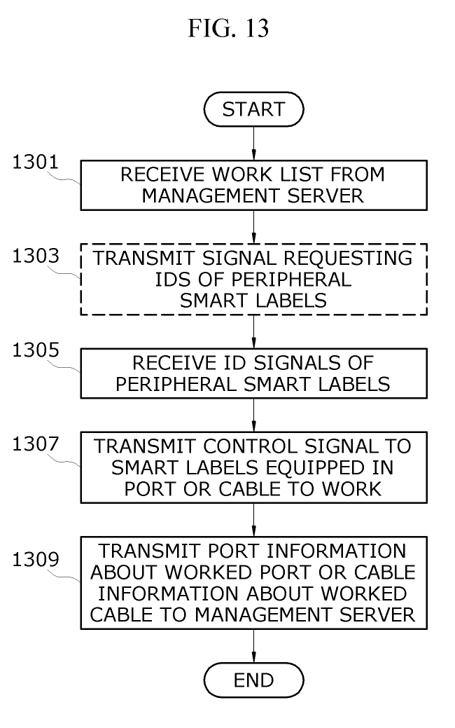

FIG. 13 is a flowchart illustrating an operation of the terminal device of FIG. 3.

Referring to FIG. 13, in step 1301, the terminal device may receive a work list from a management server. The work list may include cable information about a cable to work and port information about a port to work. The cable information may include an ID of a smart label equipped in a corresponding cable, and the port information may include an ID of a smart label equipped in a corresponding port. A worker may perform a work, based on the work list. Here, the work may include at least one of an operation of fastening a cable to a port, an operation of removing the cable from the port, and an operation of checking a connection state between the port and the cable.

The worker may identify IDs of smart labels located near the terminal device, for performing one or more works included in the work list. For example, in step 1303, the terminal device may request IDs of the smart labels from the smart labels. In an embodiment, step 1303 may be omitted. For example, without an operation of requesting, by the terminal device, the ID of the smart label, the smart label may broadcast an ID signal, and the terminal device may receive the ID signal to obtain the IDs of the smart labels located near the terminal device in step 1305.

In step 1307, the worker may check, through the work list, an ID of a smart label which is to be worked, and may control the terminal device to transmit a control signal to the smart label which is to be worked. In an embodiment, the control signal may be a signal for controlling elements included in the smart label. For example, the control signal may be a signal for controlling turn-on/off of a display unit included in the smart label. In an embodiment, the control signal may be a signal for controlling an operation of a sensor unit included in the smart label.

In step 1309, the worker may perform a desired work, and then, the terminal device may transmit port information about a worked port or cable information about a worked cable to the management server.

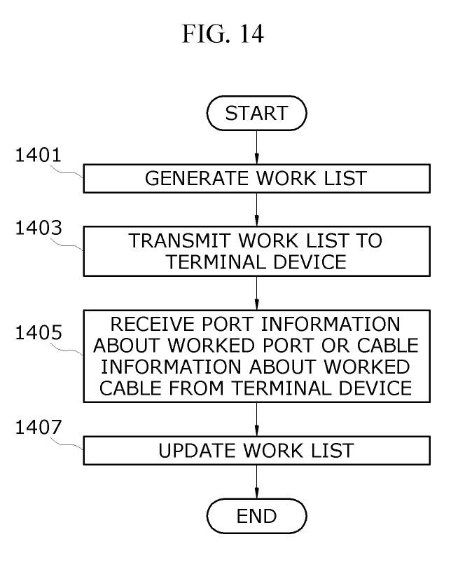

FIG. 14 is a flowchart illustrating an operation of the management server of FIG. 4.

Referring to FIG. 14, in step 1401, the management server may generate a work list. The work list may include cable information about a cable to work and port information about a port to work. The cable information may include an ID of a smart label equipped in a corresponding cable, and the port information may include an ID of a smart label equipped in a corresponding port. A worker may perform a work, based on the work list. Here, the work may include at least one of an operation of fastening a cable to a port, an operation of removing the cable from the port, and an operation of checking a connection state between the port and the cable. In an embodiment, the management server may generate separate work lists, based on the kind of a work which is to be performed.

In step 1403, the management server may transmit the generated work list to a terminal device.

In step 1405, the management server may receive port information about a port which has been worked by the worker and cable information about a cable, which has been worked by the worker, from the terminal device. In an embodiment, the management server may receive an updated work list. In this case, step 1407 may be omitted.

In step 1407, the management server may update the work list, based on the received port information and cable information.

According to an embodiment of the present invention, an optical network infrastructure can be effectively managed by using smart labels equipped in a port and a cable of each node of an ODN, a terminal device communicating with the smart labels, and a management server that communicates with the terminal device to transmit or receive various pieces of data. Here, the smart labels may each be an RFID tag, and the terminal device may be an RFID reader.

In an optical network infrastructure management method of the related art, an active device (for example, an RFID reader, an RFID writer, an antenna, or the like) for reading and writing an ID of an optical cable connector should be included in each port of a node. Also, power for driving the active device is needed. Therefore, a conventional node cannot be used as-is, and should be changed to or replaced with a node having a new function. For this reason, the cost can considerably increase compared to a conventional passive node.

According to an embodiment of the present invention, a node and an optical cable which are conventionally used may be used as-is, and a target port and a target cable which are to be worked can be effectively found by using smart labels respectively equipped in a port and a cable of a node.

Moreover, a terminal device may generate a signal for finding a port and a cable which are to be worked at a workplace, based on a work list received from the management server, and by turning on/off a display unit of a smart label receiving the signal, a work (fastening, removing, checking, etc.) may be effectively performed.

According to the embodiments of the present invention, an enhanced optical network may be managed by using a conventional passive node as-is.

According to the embodiments of the present invention, a worker can intuitively identify a port and a cable which are to be worked.

According to the embodiments of the present invention, a smart label that performs various operations in addition to identifying a port and a cable is provided.

An embodiment of the present invention may be implemented in a computer system, e.g., as a computer readable medium. A computer system may include one or more of a processor, a memory, a user input device, a user output device, and a storage, each of which communicates through a bus. The computer system may also include a network interface that is coupled to a network. The processor may be a central processing unit (CPU) or a semiconductor device that executes processing instructions stored in the memory and/or the storage. The memory and the storage may include various forms of volatile or non-volatile storage media. For example, the memory may include a read-only memory (ROM) and a random access memory (RAM). Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

As described above, although the limited embodiment of the present invention has been described with reference to the drawings, the present invention is not limited to the above-describe embodiment, and various corrections and modifications may be made from the above description by those of ordinary skill in the art.

Also, those of ordinary skill in the art will readily appreciate that many alternation, combination and modifications, may be made according to design conditions and factors within the scope of the appended claims and their equivalents.

In the above-described embodiments, all operations may be selectively performed or may be omitted. Also, in the embodiments of the present invention, the order of described operations may be changed, and some elements or features in a specific embodiment may be included in another embodiment or replaced with a corresponding element or feature in another embodiment. Also, the embodiments of the present invention disclosed in the present specification and the drawings are merely specific examples for easily describing the technical details of the present specification and helping understand the present specification, and do not limit the scope of the present specification. That is, it is obvious to those of ordinary skill in the art that various modification embodiments can be implemented based on the technical spirit of the present specification.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical network management apparatus comprising:
one or more smart labels respectively equipped in ports and cables to work; and
a terminal device configured to transmit control signals, which control smart labels respectively equipped in a port and a cable to work among the one or more smart labels, to smart labels respectively equipped in the port and the cable to work.

2. The optical network management apparatus of claim 1, further comprising a management server configured to transmit a work list, including port information about a port to work and cable information about a cable to work, to the terminal device and receive port information about a worked port and cable information about a worked cable from the terminal device.

3. The optical network management apparatus of claim 1, wherein the work comprises at least one of an operation of fastening the cable to the port, an operation of removing the cable from the port, and an operation of checking a connection state between the port and the cable.

4. The optical network management apparatus of claim 1, wherein the one or more smart labels each comprises:
a display unit configured to emit light;
a communication unit configured to transmit identification (ID) of each of the one or more smart labels to the terminal device and receive the control signals from the terminal device; and
a control unit configured to change an emission state of the display unit according to the control signals.

5. The optical network management apparatus of claim 1, wherein the one or more smart labels are charged by the control signals received from the terminal device.

6. The optical network management apparatus of claim 2, wherein the management server comprises:
a storage unit configured to store port information and cable information about nodes of an optical network;
a control unit configured to generate the work list, based on the port information and the cable information; and
a communication unit configured to transmit the generated work list to the terminal device.

7. The optical network management apparatus of claim 6, wherein the control unit updates the work list, based on the port information about the worked port and the cable information about the worked cable, which are received from the terminal device.

8. The optical network management apparatus of claim 2, wherein the terminal device comprises:
a communication unit configured to receive the work list, including the port information and the cable information, from the management server and transmit a control signal to the smart labels respectively equipped in the port and the cable to work;
a display unit configured to display the work list to a worker; and
a control unit configured to provide a control signal, which issues a command to perform an operation of each of the smart labels respectively equipped in the port and the cable to work, to the smart labels respectively equipped in the port and the cable to work according to an input of the worker.

9. The optical network management apparatus of claim 8, wherein the terminal device further comprises an input unit configured to receive the input of the worker and transfer the received input to the control unit.

10. The optical network management apparatus of claim 8, wherein the display unit provides the work list to the worker through a user interface.

11. A smart label comprising:
a communication unit configured to receive control signals, which issue a command to perform operations of one or more elements included in the smart label, from a terminal device; and
a control unit configured to perform the operations of the one or more elements corresponding to the control signals.

12. The smart label of claim 11, further comprising a conversion unit configured to decode the received control signals to transfer the decoded control signals to the control unit.

13. The smart label of claim 11, wherein the one or more elements each comprise a display unit configured to identify a port or a cable equipped with the smart label.

14. The smart label of claim 11, wherein the one or more elements are set to an on or off state according to the control signals.

15. The smart label of claim 11, wherein the smart label is equipped in a connector connecting a cable and a port.

16. The smart label of claim 11, wherein the smart label is equipped in a port which is to be fastened to a cable.

17. The smart label of claim 11, wherein the smart label is equipped in a node including a port which is to be fastened to a cable.
